(19) United States
(12) Patent Application Publication
(10) Pub. No.: US 2008/0288324 A1
(43) Pub. Date: Nov. 20, 2008

(54) Computer system and method for evaluating scientific institutions, professional staff and work products

(76) Inventors: Marek Graczynski, Warsaw (PL); Tomasz Wlaszczuk, Warsaw (PL)

Correspondence Address: RASHIDA A. KARMALI, 99 WALL STREET, 13TH FLOOR, NEW YORK, NY, 10005, US

(21) Appl. No.: 11/483,734

(22) Filed: Jul. 10, 2006

Related U.S. Application Data
(63) Continuation-in-part of application No. 11/448,703, filed on Jun. 7, 2006, now abandoned.
Application No. 11/448,703 is a continuation-in-part of application No. 11/216,663, filed on Aug. 31, 2005, now abandoned.

(51) Int. Cl. G06Q 99/00; G06F 17/30

(52) U.S. Cl. 705/10; 705/1; 707/104.1; 707/E17.044

(57) ABSTRACT

A system and method for evaluating the productivity of scientific institutions, performance of their personnel and quality of their work products using electronic evaluation forms and global or customized scoring systems. The computer based evaluation system uses a plurality of evaluating devices and data storage systems including a module management system, a module database evaluation system and a user database management system. The process involves the collection of performance data, the processing and evaluation of the data and generation of evaluation reports and tables. The system and method further comprise recordation of the number of downloads registered for accessing articles by scientists who use the system and calculating a value score. The data processed provide useful estimates for the intellectual potential factor of articles, the research potential factor of individual scientists, the innovation potential of individual scientists and the teaching potential of professional staff.

### CROSS-REFERENCE TO OTHER APPLICATION

This application is a Continuation-in-part of U.S. patent application Ser. No. 11/448,703 filed on Jun. 7, 2006, with is a Continuation-in-part of U.S. patent application Ser. No. 11/216,663, filed on Aug. 31, 2005, all of which are is incorporated herein, with references in their entirety.

### FIELD OF INVENTION

The present invention relates generally to an Evaluation System called INDEX COPERNICUS™, method and program for evaluating productivity of scientific institutions, universities, industry, publishers, libraries, students or administrators, among others, their personnel and their work products including, but not limited to scientific publications, research programs, grants, courses offered, and others. More specifically, the present invention provides a computer-based system for evaluating complex scientific information using evaluation criteria that are standardized to provide a unique system to carry out global performance criteria. Importantly, the present invention provides a computer system evaluates 1) the quality articles through scoring the journals and assigning a Journal Index Copernicus value (JICV) and depending on the type of an article assign a score; 2) the quality of institutions is based on the sum of all individual scientists' multi-parametric career evaluation for scientists who work for the institution through calculating the “intellectual potential factor”. Thus an increasing “intellectual potential factor” will yield an INDEX COPERNICUS™ (IC) value that is favorable to the reputation and value of an institution, its scientists, its authors and the journals they publish in. Conversely, a low IC value for the intellectual potential factor will alert the journal or institution, for a need to improve and take remediation measures; 3) the “research potential factor” of scientists by calculating a score of i) the sum of original publications of a scientist in any or selected journals+number and size of grants awarded to the scientist+the number of research projects being conducted by the scientist, as a function of the Index Copernicus Value (ICV), and optionally ii) the “scientist's impact factor” calculated as a number of citations of articles published by a scientist in the current year for articles published in previous two years, divided by the number of articles published by the scientist in those two years in all journals or in a selected category of journals; 4) the “innovation potential factor” of a scientist-based on a cumulative score of the total number of patents issued (and/or pending) to the scientist+corresponding foreign patents,+number of patents that result in technology development and commercialization; and 5) the “teaching potential factor” of a scientist based on scores for number of publications such as review articles and books+role as advisor or mentor to graduate and postgraduate candidates+participation as faculty for continuing education programs, divided by ICV.

### BACKGROUND TO THE INVENTION

Most of the existing scientific information systems provide information that is bibliographic in nature. Bibliographic databases provide quantitative information on scientific achievements or publications produced by individual scientists and institutions, but do not provide information on other scientific activities going on at various scientific institutions, for example, research programs, clinical trials, drug development and testing, technology transfer, intellectual property development, among others. Furthermore, even the limited information available on published papers does not provide information on the quality of the published papers and often the quality of the paper is judged by the address of the authors and the popularity of the journal, rather than on quality of the content. It is not surprising that so much emphasis is placed on publishing as the criterion of academic excellence since bibliographic data is readily available. Yet these single pieces of scientific information are only of limited value. There is need for a comprehensive approach to integrate and link several different information areas to effortlessly lead from one type of information to another. For example, an efficient scientific database should include services like the Journals Master List, Case Reports Register, or Clinical Trials Register. The present invention provides such an interactive system and combines different information areas useful to academic level researchers, clinical practitioners, information and reprint providers, librarians, journal editors, industry, scientific institutions, universities, or government agencies. The evaluation system of the present invention, INDEX COPERNICUS, provides in addition, a qualitative evaluation of the performance of the various scientific systems.

### SUMMARY OF THE INVENTION

In the first aspect of the present invention, a computer based system is provided for evaluating performance of scientific institutions, universities, industry, publishers, libraries, students or administrators, among others, their personnel and their work products including, but not limited to scientific publications, research programs, grants, courses offered, and others. The system and method include the steps of registering a member, making available to the member user a first set of electronic forms consisting of specific questions for collecting in depth and standardized data for evaluation, in putting the first set of data into electronic form into IDEX COPERNICUS's evaluation data base, evaluating the first set of data to generate results in the form of scores for specific categories of information and storing said scores generated in INDEX COPERNICUS's reports data base.

In another aspect of the present invention the system and method are adapted to improve the accuracy and efficacy of the evaluation process on a real-time or near real-time basis.

In yet another aspect of the present invention the system and method provide an evaluation methodology and data structure designed to enable tailoring to the needs and requirements of an individual institution, country or culture.

A principal object of the present invention is to provide an effective system for registering users such as scientific institutions, universities, industry, publishers, libraries, students or administrators, among others, collecting evaluation data, evaluating and processing said data and storing the processed data for reporting.

Another object of the present invention is to provide a system for evaluating data collected, using an evaluation system established to improve the accuracy and efficacy of the evaluation process on a real-time or near real-time basis. Data collected for evaluation comprises data in different scientific fields including, but not limited to, journals, news articles, scientists, ongoing research projects, clinical trials, case reports, patents, grants, funding opportunities, business organizations, job postings, medical consultants, therapeutics directory, professional or career development.

Another object of the present invention is to provide an evaluation methodology and data structure designed to apply standardized scoring on a uniform, global basis for all scientific institutions, universities, industry, publishers, libraries, students or administrators, among others, their personnel and their work products including, but not limited to scientific publications, research programs, grants, courses offered, and others.

Another object of the present invention is to provide an evaluation methodology and data structure designed to apply to enable tailoring the NDEX COPERNICUS evaluation system to an individual institution.

Another object of the present invention is to provide an evaluation methodology and data structure designed to apply standardized scoring on a country basis for all scientific institutions, universities, industry, publishers, libraries, students or administrators, among others, their personnel and their work products including, but not limited to scientific publications, research programs, grants, courses offered, and others.

Another object of the present invention is to provide an evaluation methodology and data structure designed to enable member institutions to customize the scoring system for internal use, according to needs, culture and traditions by selecting specific parameters to generate individual category and cumulative scores for internal monitoring and evaluation.

Still another object of the present invention is to provide a system that produces timely performance reports that are capable of delivering evaluation scores for overall performance as well as for particular areas of performance.

Another object of the present invention is to provide system security and controlled access to data in INDEX COPERNICUS data bases through use of pass words.

Still another object of the present invention is to record the number of downloads that an article registers electronically to indicate the quality of the article, the value of the journal and the “intellectual potential” for the journal by calculating an IC value or score. To prevent counts of false downloads or cheating the system counts users who download, since the downloads can be done only through users who have an INDEX COPERNUCUS account.

Yet another object of the present invention is to record the number of downloads a scientist or the scientist's institution receives through downloads of journal articles, by calculating the IC value or score for the “intellectual potential factor”. To prevent counts of false downloads or cheating the system counts users who download, since the downloads can be done only through users who have an INDEX COPERNUCUS account.

Another object of the invention is to estimate the “research potential factor” of scientists by calculating a score of i) the sum of original publications of a scientist in any or selected journals+number and size of grants awarded to the scientist+the number of research projects being conducted by the scientist, as a function of the Index Copernicus Value (ICV), and optionally ii) the “scientist's impact factor” calculated as a number of citations of articles published by a scientist in the current year for articles published in previous two years, divided by the number of articles published by the scientist in those two years in all journals or in a selected category of journals.

An additional object of the invention is to estimate the “innovation potential factor” of a scientist based on a cumulative score of the total number of patents issued (and/or pending) to the scientist+corresponding foreign patents,+number of patents that result in technology development and commercialization.

A further objective of the invention is to estimate the “teaching potential factor” of a scientist based on scores for number of publications such as review articles and books+role as advisor or mentor to graduate and postgraduate candidates+participation as faculty for continuing education programs, divided by ICV.

These and other objects of the present invention will become more clear from the following detailed description of the preferred embodiments, particularly when read in conjunction with the drawings which form a part of the specification.

### BRIEF DESCRIPTION OF THE DRAWINGS

For a fuller understanding of the invention, reference is made to the following description, taken in connection with the accompanying drawings, in which:

FIG. 1 is a flow diagram that shows the login by a New User into the Index Copernicus System. This leads the user to enter the Registration Page and enter information such as a) First Name and Last Name, b) correspondence address, c) telephone and fax numbers and e-mail, and d) specialty of profession. The potential users of the INDEX COPERNICUS evaluation system, include publishers, libraries, students, scientists, professionals, universities, scientific institutions, industry or administration. For example, the INDEX COPERNICUS Home Page may be linked to an individual User's Home Page, an Institutional User's Home Page or Corporate User's Home Page.

FIG. 2 is a flow diagram that describes the organization of a User's Home page, in terms of the plurality of services provided and the links to the corresponding data bases.

FIG. 3 is a flow diagram showing a User's Home Page providing information on the user's profile, including but not limited to, personal information, career, conferences, publications, reports or research.

FIG. 4 is a flow diagram showing the algorithm to display information on evaluation of journals and the abstract database according to a user's specialty or profile.

FIG. 5 is an IC Evaluation Chart showing algorithms for the evaluation processes for journals and for scientists and institutions they work at through recordation of downloads and calculating a number of scores including a value score, an intellectual potential factor, a research potential factor, a scientist's impact factor, an innovation potential factor, or a teaching potential factor.

### DETAILED DESCRIPTION OF THE INVENTION

A computer based system is provided for evaluating performance of scientific institutions, universities, industry, publishers, libraries, students or administrators, among others, their personnel and their work products including, but not limited to scientific publications, research programs, grants, courses offered, and others. The system and method include the steps of registering a member, making available to the member user a first set of electronic forms consisting of specific questions for collecting in depth and standardized data for evaluation, in putting the first set of data into electronic form into INDEX COPERNICUS's evaluation data base, evaluating the first set of data to generate results in the form of scores for specific categories of information and storing said scores generated in INDEX COPERNICUS's reports data base. The computer based evaluation system uses a plurality of data storage systems including a module management system, a module database evaluation system and a user database management system. The process involves the collection of performance data, the processing and evaluation of the data and generation of evaluation reports and data bases.

Importantly, the present invention provides a computer system evaluates 1) the quality articles through scoring the journals and assigning a Journal Index Copernicus value (JICV) and depending on the type of an article assign a score, and 2) the quality of institutions is based on the sum of all individual scientists' multiparametric career evaluation for scientists who work for the institution through calculating the “intellectual potential factor”. Thus an increasing “intellectual potential factor” will yield an INDEX COPERNICUS™ (IC) value that is favorable to the reputation and value of an institution, its scientists, its authors and the journals they publish in. Conversely, a low IC value for the intellectual potential will alert the journal or institution, for a need to improve and take remediation measures.

“Intellectual Potential factor” for articles or Article Intellectual Potential Factor (AIPF) represents a calculation of the average of value of the Scientists INDEX COPERNICUS Value (SICV) who download the article times the number of scientists, divided by 1000. Therefore, for example if an Article is downloaded by 200 scientists with an average of SICV of 5, its APF will be 200×5/1000=1. Therefore, if the article with the SICV of 5 is downloaded by 100 scientists, its prestige value is higher than an article downloaded by 200 scientists with an average SICV of 2.

“Research Potential Factor” (RPF) of scientists by calculating a score of i) the sum of original publications of a scientist in any or selected journals+number and size of grants awarded to the scientist+the number of research projects being conducted by the scientist, as a function of the Index Copernicus Value (ICV), and optionally ii) the “scientist's impact factor” calculated as a number of citations of articles published by a scientist in the current year for articles published in previous two years, divided by the number of articles published by the scientist in those two years in all journals or in a selected category of journals.

“Innovation Potential Factor” (IPF) of a scientist based-on a cumulative score of the total number of patents issued (and/or pending) to the scientist+corresponding foreign patents,+number of patents that result in technology development and commercialization.

“Teaching Potential Factor” (TPF) of a scientist based on scores for number of publications such as review articles and books+role as advisor or mentor to graduate and postgraduate candidates+participation as faculty for continuing education programs, divided by ICV.

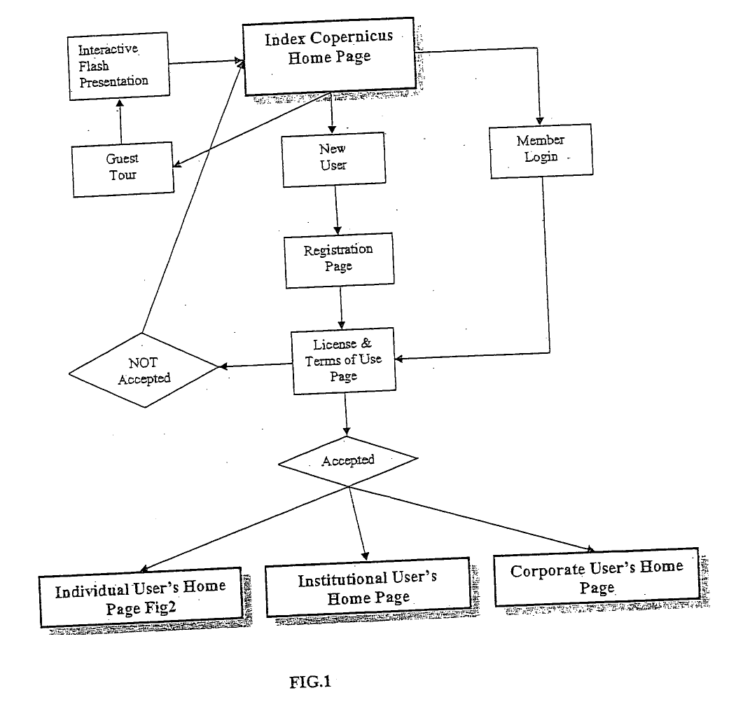

FIG. 1 describes the overall INDEX COPERNICUS system comprising the central server that is connected to an individual user, an institutional user or a corporate user through the internet. Once the user logs in to the INDEX COPERNICUS system, the user is offered the option to register and become a member. The user is also offered a guest tour describing the features of the INDEX COPERNICUS system and the benefits of membership. If the user accepts the terms of the license, the user enters the registration page and submits information such as name, address of scientific institution (street address, telephone and fax number, and e-mail address) and field of scientific specialization. The user is then invited to complete evaluation forms for scientific data that the user wants to be posted on the user's home page and/or in the plurality of data bases in the INDEX COPERNICUS system, for example on journals, news articles, scientists, ongoing research projects, clinical trials, case reports, patents, grants, funding opportunities, business organizations, job postings, medical consultants, therapeutics directory, professional or career development.

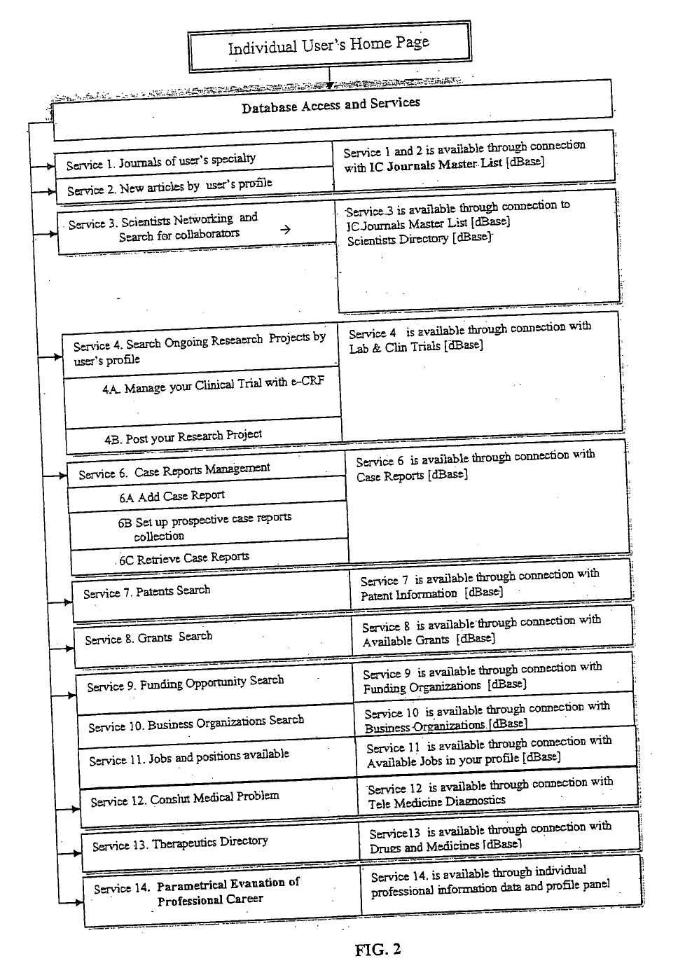

FIG. 2 describes in detail the relationship between the INDEX COPERNICUS data base access and services for a User's Home page. The different data bases containing evaluated-scientific data are represented as types of services, for example Service 1 through Service 14.

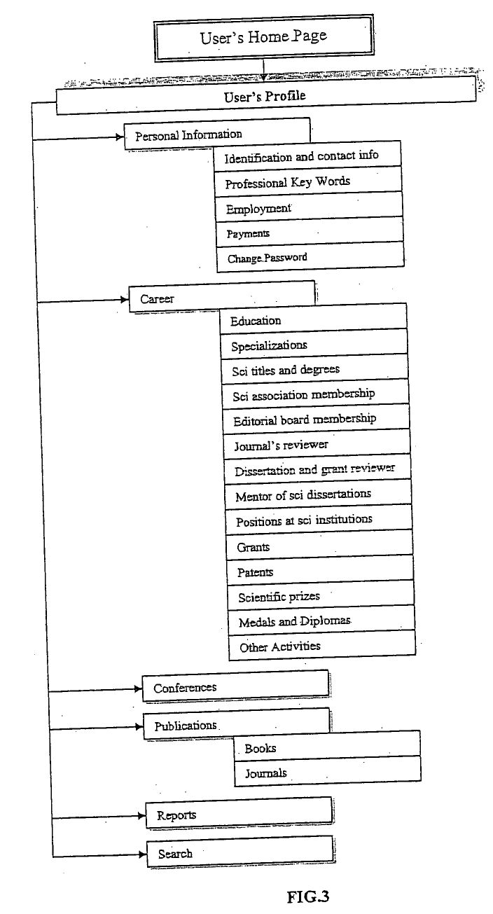

FIG. 3 describes the individual user's profile including personal information (identification and contact information, professional key words, employment, payments, or change password), career (education, specializations, titles and degrees, memberships in associations, editorial board membership, journal reviewer, dissertation and grant reviewer, mentor for dissertations, positions at scientific institutions, grants, patents, scientific prizes, medals and diplomas or other activities), conferences attended, presented or organized, publications in books or journals, reports published and search record.

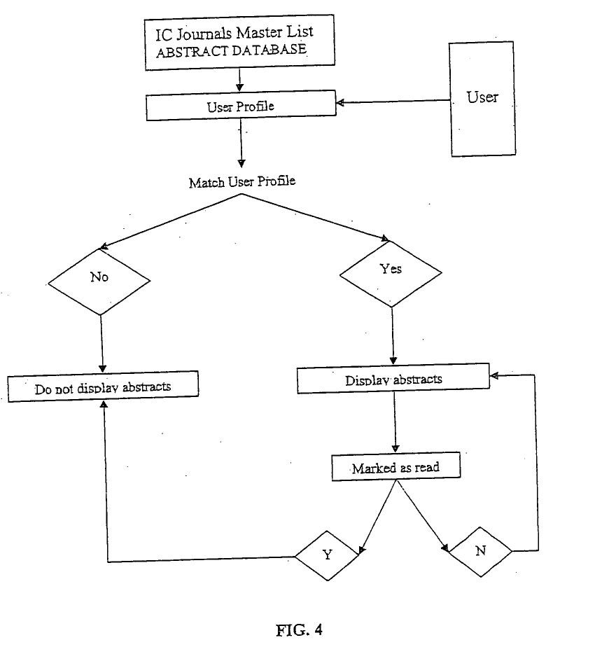

FIG. 4 describes the INDEX COPERNICUS system used to evaluate journals, described in greater detail below in the EXAMPLES section. The algorithm described displays information on journals according to the user's profile. Each journal and the Scientist's profile are described by keywords, and each scientist is supplied with journals that match the user's profile. In this way the user is updated with current literature and publications more specifically and in real time.

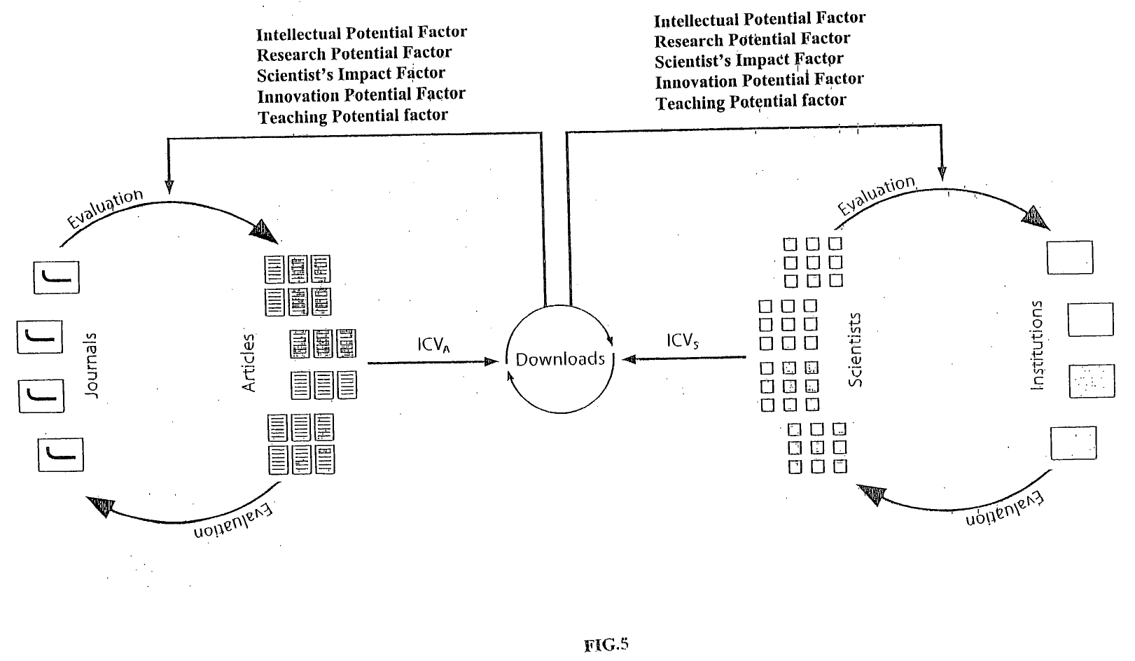

FIG. 5 describes the INDEX COPERNICUS evaluation chart used to evaluate the “intellectual potential factor” of 1) articles through scoring the journals and assigning a Journal Index Copernicus value (JICV) and depending on the type of an article assign a score; 2) the quality of institutions is based on the sum of all individual scientists' multiparametric career evaluation for scientists who work for the institution through calculating the “intellectual potential factor”, sometimes referred to as “prestige factor” in literature. Thus an increasing “intellectual potential factor” will yield an INDEX COPERNICUS™ (IC) value that is favorable to the reputation and value of an institution, its scientists, its authors and the journals they publish in. Conversely, a low IC value for the intellectual potential will alert the journal or institution, for a need to improve and take remediation measures; 3) the “research potential factor” of scientists by calculating a score of i) the sum of original publications of a scientist in any or selected journals+number and size of grants awarded to the scientist+the number of research projects being conducted by the scientist, as a function of the Index Copernicus Value (ICV), and optionally ii) the “scientist's impact factor” calculated as a number of citations of articles published by a scientist in the current year for articles published in previous two years, divided by the number of articles published by the scientist in those two years in all journals or in a selected category of journals; 4) the “innovation potential factor” of a scientist based on a cumulative score of the total number of patents issued (and/or pending) to the scientist+corresponding foreign patents,+number of patents that result in technology development and commercialization; and 5) the “teaching potential factor” of a scientist based-on scores for number of publications such as review articles and books+role as advisor or mentor to graduate and postgraduate candidates+participation as faculty for continuing education programs, divided by ICV.

The present invention provides an evaluation system and method comprising electronic evaluation forms that are generated for different information categories, and issued to the member users, for example, the scientific institutions, universities, industry or students. These evaluation forms include content that solicits specific feedback from the member user. An evaluation form is completed by the user and returned to the evaluator. The evaluator processes the data submitted using the INDEX COPERNICUS scoring system and issues an evaluation report.

Tables 1 to 16 show the specific electronic forms that should be completed to process performance data in the following categories:
1. Personal Identification and Contact Information. Table 1 shows the evaluation form soliciting feedback from the member user.

TABLE 1
PERSONAL IDENTIFICATION AND CONTACT INFORMATION

First Name
Middle Initial
Last Name
Picture [optional]
Correspondence address

| | |
|---|---|
| -work | home [optional] |
| institution | |
| department | |
| address line 1 | address line 1 |
| address line 2 | address line 2 |
| city | city |
| state | state |
| zip code | zip code |
| country | country |
| phone | phone |
| fax | fax |
| e-mail | e-mail |

2. Current Position and Employment History. Table 2 shows the Evaluation form soliciting feedback from the member user.

TABLE 2
CURRENT POSITION AND EMPLOYMENT HISTORY

```
The purpose of this information is to identify scientists/researchers affiliated with an
institution. Evaluation of institutions is based on sum of individual scores achieved by
affiliated researchers in a given year. This information enables institutions scores to be
provided for indicated period of time [under condition that all researchers/scientists
participate in the program].
The following information is collected:
  Name of Institution/University [list]
  Name of Department [list]
  Lab [list]
  [*] type-in option is provided if an item not found on the list. Once typed-in, the
  institution/department/lab name is added to the list
  Position
  start date
  end date
Start and end dates for positions held and affiliation with an instiution have to be provided
```

3. Education, Specialties, Titles, Scientific Degrees. Table 3 shows the evaluation form soliciting feedback from the member user.

TABLE 3
EDUCATION

```
Education history information is optional, however recommended to be included into the
individual profile. It helps to build up the complete picture of individual career.
The following information is collected:
University Name
    Faculty
    Division/Direction
  City
  State
  Country
  start date
  graduation date
  title received
```

SPECIALTIES [BOARD ELIGIBLE/BOARD CERTIFIED]

```
Each specialty certificate adds score to the profile only once in a giving year.
The following information on specialties is collected:
  [SCORE]Name of specialization [list]
    certification date
    number of certificate
    Institution issuing the certificate
    City
    State
    Country
```

TITLES AND SCIENTIFIC DEGREES

```
Each title or a degree adds score to the profile only once, in the promotion year.
The following information is collected:
Title or scientific degree
  [SCORE] Bachelor
  [SCORE] master/MD
  [SCORE] PhD
  [SCORE] doctor honoris causa.
  [SCORE] DSc [European habilitation]
  [SCORE] full professorship [an academic degree]
Base of the title
    Title of dissertation
    Mentor
      Firs Name/Last Name
    University/Institution which issued the title
      City
      State
      Country
Date of promotion
```

4. Membership in Scientific Societies. Table 4 shows the evaluation form soliciting feedback from the member.

TABLE 4
MEMBERSHIP IN SCIENTIFIC SOCIETIES

```
Each membership adds score to the profile every year throughout the whole period of
membership.
The score depends on:
  the position held in a society, which is indirect indicator of an appreciation/respect of
  an individual
  whether the position held is assign to the local chapter or main board of a society
  span [national/international] of a society
For instance: a treasurer of a local chapter of national society will score less than a treasurer
of a main board of the international society.
The following information is collected:
Name of society/association [from list]
    [*] one can add a new name to the list
    start date
    end date
Positions held  [1]
    [SCORE] member
    [SCORE] board member
    [SCORE] secretary
    [SCORE] treasurer [for example 5]
    [SCORE] vice president
    [SCORE] president
    [SCORE] honorary member
    [SCORE] other [*] one can add a new position
    start date
    end date
Position Span  [2]
    [FACTOR] local chapter [×0.5]
    [FACTOR] main board  [×1.0]
Span of Society  [3]
    [FACTOR] national  [×1.0]
    [FACTOR] international [×2.0]
Calculation examples:
  A. Treasurer of a local chapter of international society:
[Treasurer's score] × [local chapter factor] × [international soc. factor]
5 × 0.5 × 2 = 5
  B. Treseaurer of a main board of international society
[Treasurer's score] × [mian board factor] × [international soc. factor]
5 × 1 × 2 = 10
```

5. Membership in Journals, Editorial Boards. Table 5 shows the evaluation form soliciting feedback from the member user.

TABLE 5
JOURNALS EDITORIAL BOARDS MEMBERSHIP

```
Editorial Boards membership and position within the board is a direct sign of professional
respect. Each membership adds score to the profile every year throughout the whole period of
membership. The following information is collected:
Journal's Title [from list]
  [*] one can add a new title
  international/local
International recognition of a journal:
  [SCORE] non-NIH listed/non-ISI listed
  [SCORE] NIH listed/non-ISI listed [Medlined journals]
  [SCORE] NIH listed and/or ISI listed [journals on ISI's Journals Master List]
These represents three groups of journals: [a] non-indexed journals; [b] Medline journals; and
[c] quality journals from Philadelphia ISI's Journals Master List
Functions held
  [FACTOR] editor in chief
  [FACTOR] deputy editor in chief
  [FACTOR] section editor
  [FACTOR] member of the editorial board
  [FACTOR] other
  start date
  end date
The position within a Medline group journal should score more than within a non-indexed
journals group, and score less than in a journal from the ISI list. The calculation is done by
multiplication of a given [score] × [corresponding factor]
```

6. Reviewer of Scientific Journals. Table 6 shows the evaluation form soliciting feedback from the member user.

TABLE 6
PEER-REVIEWER OF SCIENTIFIC JOURNALS

```
Being a peer-reviewer of manuscripts submitted to scientific journals is a direct sign of
professional respect. Each manuscript evaluation adds score to the profile. The score depends
on the journal's quality category based on international indexation. The following
information is collected:
International recognition of a journal:
  [SCORE] non-NIH listed/non-ISI listed
  [SCORE] NIH listed/non-ISI listed [Medline journals]
  [SCORE] NIH listed and/or ISI listed [journals on ISI's Journals Master List]
These represents three groups of journals: [a] non-indexed journals; [b] Medline journals; and
[c] quality journals from Philadelphia ISI's Journals Master List
Journal title [from list]
Reviewed manuscript title
Reviewed manuscript 1^{st} author
Review date
```

7. Review of dissertations and grants. Table 7 shows the evaluation form soliciting feedback from the member user.

TABLE 7
PEER-REVIEWER OF SCIENTIFIC DISSERTATION, GRANTS
AND OTHER SCIENTIFIC WORKS

```
The following information is collected:
Type of review
  [SCORE] master degree
  [SCORE] PhD
  [SCORE] DSc
  [SCORE] doctorate honoris causa
  [SCORE] grant proposal or other scientific work
Details of a review:
    title of the reviewed work
    author[s]
    institution
    city/state/country
    date of review
```

8. Membership in Graduate Student Committees. Table 8 shows the evaluation form soliciting feedback from member user.

TABLE 8
MENTOR OF SCIENTIFIC DISSERTATIONS

```
The following information is collected:
Type of dissertation
  [SCORE] master degree
  [SCORE] PhD
  [SCORE] DSc
  [SCORE] doctorate honoris causa
Details of the mentored work:
    Title of dissertation
    First Name, Last Name
    Institution
    City/State/Country, date of defence
```

9. Academic Positions. Table 9 shows the evaluation form soliciting feedback from the member user.

TABLE 9
POSITIONS AND FUNCTIONS AT SCIENTIFIC INSTITUTIONS AND
UNIVERSITIES

```
The following information is collected:
Institution Type
  University/College
  Research Institute
Name of Institution/University [from list]
  [*] one can add to the list
Position held:
  [SCORE] member of Senate/Board
  [SCORE] Vice Dean [indicate Faculty]
  [SCORE] Dean [indicate Faculty]
  [SCORE] Vice Rector [for...]
  [SCORE] Rector
  [SCORE] Deputy Director
  [SCORE] Director
  [SCORE] other [indicate]
Institution category
  [FACTOR] national
  [FACTOR] international
  start date
  end date
```

10. Grants. Table 10 shows the evaluation form soliciting feedback from member user.

TABLE 10
GRANTS

```
Function  [A]
  [SCORE] Principal coordinator
  [SCORE] Member of the coordinating board
  [SCORE] Principal investigator
  [SCORE] Investigator
Type of grant  [B]
  [FACTOR] individual
  [FACTOR] for a young scientist
  [FACTOR] team
  [FACTOR] educational
Grant's range  [C]
  [FACTOR] local
  [FACTOR] nationwide
  [FACTOR] international
Grant's value $ [D]
  [FACTOR] Up to 50.000
  [FACTOR] Up to 100.000
  [FACTOR] Up to 500.000
  [FACTOR] Up to 1.000.000
  [FACTOR] Over 1.000.000
  start date
  end date
  description of grant
Grant score calculation: [A] × [B] × [C] × [D]
```

11. Patents. Table 11 shows the evaluation form soliciting feedback from the member user.

TABLE 11
PATENTS

```
The score depends on the patent status and range. The following
information is collected:
Patent Status
  [SCORE] patent
  [SCORE] patent pending
Patent Number
Patent's Range
  [FACTOR] national
  [FACTOR] international
  date of submission
  date of certification
  patent's description
```

12. Scientific Prizes and Honors. Table 12 shows the evaluation form soliciting feedback from the member user.

TABLE 12
SCIENTIFIC PRIZES

```
Only prizes and honors associated with professional achievements
are scored. The score depends on the type of awarding institution/body,
its range, type of awarded activity, and type of prize. The following
information is collected:
Awarding Institution
  [SCORE] scientific society
  [SCORE] university/college/research institute
  [SCORE] government
  [SCORE] other [indicate]
Type of prize
  [FACTOR] individual
  [FACTOR] team
Range
  [FACTOR] national
  [FACTOR] international
Activity Type
  [FACTOR] scientific achievement
  [FACTOR] teaching achievement
  [FACTOR] organization achievement
  description
  date of receive
```

13. Other Honors. Table 13 shows an evaluation form soliciting feedback from the member user.

TABLE 13
OTHER MEDALS, DIPLOMAS AND HONORS

```
Not scored. The following information is collected:
Type
  medal
  diploma
  distinction
Range
  national
  international
description
receiving date
```

14. Scientific Meetings and Conferences. Table 14 shows the evaluation form soliciting feedback from the member user.

TABLE 14
PARTICIPATION AT SCIENTIFIC CONFERENCES AND MEETINGS

```
Title of the conference
  place - city
  place - country
  date of conference
Category  [C]
  [SCORE] workshop
  [SCORE] symposium
  [SCORE] annual meeting
  [SCORE] congress
Function  [F]
  [SCORE] chairperson of the organizing committee
  [SCORE] member of the organizing committee
  [SCORE] chairperson of the scientific committee
  [SCORE] member of the scientific committee
  [SCORE] none
Participation  [P]
  [FACTOR] passive participation
  [FACTOR] oral presentation
  [FACTOR] poster presentation
  [FACTOR] invited speaker
          title of presentation
  [FACTOR] chairperson of the session
  Range  [R]
  [FACTOR] local
  [FACTOR] nationwide
  [FACTOR] international
Calculation of Conference score: (C × F) × P × R
```

15. Publications. Table 15 shows the evaluation form soliciting feedback from the member user.

TABLE 15
PUBLICATIONS - SCIENTIFIC JOURNALS

```
Each article published in a scientific journal scores automatically according to Index
Copernicus Journals Master List Value. Index Copernicus ranks journals according to five
groups of parameters: [1] scientific quality, [2] editorial quality, [3] technical quality, [4]
span of a journal, and [5] regularity/market stability. Publication in a journal which is not
listed at Index Copernicus does not score until the journal receives the Index Copernicus
Value. The following information is collected:
Type of publication
  [FACTOR] original
  [FACTOR] review
  [FACTOR] case report
  [FACTOR] other [indicate]
Authors
Title
key words
Journal's Title [from list]
    [*] one can add new journals title
Article's signature
```

PUBLICATIONS - BOOKS

```
Score on book publication depends on type of publication and authorship, span of publication
and language. The following information is collected:
  Title of book/chapter
  Publisher
  Authors/Editors
  city/country
  ISBN
  publication date
Type
  [SCORE] manual
  [SCORE] monography
  [SCORE] other [indicate]
Authorship type
  [SCORE] author
  [SCORE] co-author
  [SCORE] editor
  [SCORE] co-editor
Authorship type II
  [FACTOR] entire book
  [FACTOR] chapter
Range of publication
  [FACTOR] national
  [FACTOR] international
Language of publication
  [FACTOR] English
  [FACTOR] other [indicate]
```

16. Key words or search terms which describe professional research interests and expertise.

In summary, the principal advantages of the present invention are derived from the use of computerized relational databases to record, store, process, evaluate abd report performance data sumbitted by the member users.

The data bases consist of a collection of tables and evaluation reports. Each table has unique information. The tables share a key data element that is used to link the tables together.

The system and method of the invention provide mechanism for efficiently collecting a broad range of data, evaluating the data using global or customized scoring systems and reporting the data on performance. This invention can be applied to a variety of other business organizations. To meet disclosure requirements, the Example used to describe the scoring system of the invention in detail relates to evaluation of journal articles.

### EXAMPLES

The following scheme provides a detailed parametric analysis of the evaluation process used by INDEX COPERNICUS to analyze performance data related to journal publications.

### Stage 1. Detailed Parametric Analysis

The following groups of parameters are being evaluated:

| | | |
|---|---|---|
| Scientific quality | 580 base points | (58.0%) |
| Editorial quality | 200 base points | (20.0%) |
| International availability | 135 base points | (13.5%) |
| Frequency-Regularity-Stability | 50 base points | (5.0%) |
| Technical quality | 35 base points | (3.5%) |
| Total | 1000 base points | (100.0%) |

### Stage 2. Negative Score Analysis

A negative score is given for:

a. irregular or late issuance [late up to one publishing period (−30), joint issues (−50), late more than one publishing period (−60)]

b. non-ethical advertisement placement [within article (−60), directly before/after article (−40)

### Stage 3. Experts Peer-Review

Expert peer-review of evaluated journals changes the total score by +/−60 points (12%)
a. Scientific significance of the published material [+/−20]
b. Up-to-date content [+/−20]
c. educational value [+/−20]

### Stage 4. Calculation of the Index Copernicus Value

First, Base Points (BP) are converted into 10 points Total Basic Score (TBS), then:

A) For journals indexed in Current Contents Index Copernicus Value (ICV) is being calculated based on the following formula:

9+[(TBS)×(IF)] (where IF=impact factor value)
This formula ensure that the journals indexed at Current Contents have minimum ICV=10 points
B) For the rest of journals which are NOT indexed in Current Contents TBS=ICV

### The Five Parameters Listed Above in Stage 1 are Evaluated as Follows (I to V)

### I. Scientific Quality

The following parameters have been evaluated:
1. International indexation. Three levels of indexation has been defined:
   a. Basic level—indexation in international bibliographic databases EXCEPT Index Medicus/MEDLINE and Current Contents
   b. MEDLINE level (indexation at Index Medicus/MEDLINE). The score can be lowered if a journal does not deliver or is late with delivering XML files according to Medline requirements.
   c. Indexation at Philadelphia Institute of Scientific Information's Master Journal List (based on impact factor). IF is used in the calculation algorithm of Index Copernicus Value (ICV)—see above.
2. Annual percent of original research papers
   Original research paper is that, which presents results of empiric investigation (clinical or laboratory), which is divided into the following sections: background, material and methods, results, discussion, conclusions, references. The percentage of this original works published in a journal reflects its character (scientific or educational) and indicates the potential interest of researchers in publishing there.
3. Number of papers published annually from centers outside the journal's country of origin
   Indirectly indicates a degree of journal's acceptance on international market. The more international publications—the higher the score.
4. Number of all papers published on annual basis
   Reflects potential authorship and acceptance for the journal. Only papers published in regular issues are being considered. Papers published in special issues or supplements are not being counted as they are considered not to undergo the regular peer-review process. It is also being assessed if the papers published in a journal come from a source associated with publisher or editorial board only, what lowers the IC score.
5. International Editorial Board adds to the score, for it creates a chance for further journal's development.

### II. Editorial Quality

All journals indexed in Index Copernicus observe the following guidelines:

1) All the following items should appear clearly on the cover (and title page where these appear) of each issue of the journal (or on the homepage of the electronic journal):

a) journal title

b) ISSN

c) frequency of issue

d) specification of the volume and issue-number, and part number if appropriate

e) year of publication (with the month, if the journal is a monthly, or exact date of publication, if the journal is a weekly)

2) The journal should clearly provide information about its editorial structure, including the following:

a) the name of the Editor-in-Chief, including their affiliation where appropriate, and the town and country where they are currently located

b) the names of the Editorial Board (or panel), etc.—with the countries where they are located

c) the names of editors responsible for specific areas—e.g. Book Reviews Editor—with the country where located

3) The journal should also clearly provide information about the publication, including the following:

a) the name and address of the publisher

b) the name of the organization that sponsors or sanctions the publication, if any

c) the journal's p-ISSN and/or e-ISSN

d) the frequency of issuance (monthly, bi-monthly, quarterly, etc.)

e) the circulation (print/electronic)

f) information on subscription and single-issue prices, method of payment, etc.

g) copyright statement (indicating how authorial rights and obligations are handled)

h) all bibliographical indexes and data bases where the journal is listed

4) A clearly labeled section entitled “Information for Authors” or the equivalent should be included in each issue of the journal, in an obvious place (traditionally inside the back cover, or just after the title page), and should contain the following:

a) general rules governing the process of evaluating manuscripts, and a statement of the journal's conformance with international editorial standards and the peer review process

b) requirements regarding disclosure of conflicts of interest between referee and author, referee and research sponsor, author and research sponsor, etc.

c) a clear statement of expectations regarding ethical conduct in clinical and animal research

d) requirements regarding observance of the patient's privacy rights and confidentiality of medical information

e) copyright statement (Editorial Policy)

f) detailed editorial and technical information regarding manuscript preparation (Instruction for Authors), including postal address, telephone number, and e-mail address where submissions and inquiries are accepted

g) A clear statement of the aims and scope (or remit) of the journal

h) A list of the types of articles the journal seeks to publish

i) clear guidance about the preparation of references (this is one of the most difficult items for authors to prepare correctly, and can undermine the credibility of a good article)

5) One of the most important elements of editorial quality is the uniform composition of the first page of published articles, compatible with the journal's Instructions for Authors.

The obligatory elements include:

a) The full title of the article. This should be no longer than is necessary to convey the gist of the article, while avoiding vagueness or incompleteness, or promising more than the article actually delivers. Journals which publish in local languages should also give the title in English.

b) The names of all the authors. Whether full first names or simply initials are given depends on the taste and judgment of the editors, but whatever policy is adopted should be applied consistently wherever possible (note: some authors will wish to be listed by their initials only even if full first names are generally given; in the Anglo-Saxon tradition such wishes are always respected).

c) The exact contribution of each co-author, preferably in the following categories:
study design
data collection
statistical analysis
data interpretation
literature search
funds collection

No one should be listed as a co-author who has not made, a significant contribution to the work. For example, the practice of automatically including as co-authors the heads of departments where the research was done (when they were not directly involved in the research), is to be actively discouraged.

d) The institutional affiliation of each author, if any. Authors without a formal affiliation (e.g. working exclusively in a private practice) should give their city of residence. The indication of academic titles and positions, such as “Prof.” or “Department Head,” is to be discouraged. At a minimum, the town and country of each author should be given, as this provides valuable information about the source of the article.

e) Sources of financial support. The name of the supporting institution and grant number should be given. One of the following three headings should be used:

i) “Supported in part by”+name of the supporting institution and grant number

ii) “Departmental sources”—for research supported solely by university/hospital funds

iii) “Self financing”—for research financed privately by authors

f) The “signature” of the journal (the name of the journal, year and volume number, and page numbers), so that all offprints of the article will contain complete bibliographic information even when detached from the rest of the journal.

g) The dates when the manuscript was received in the editorial office and when it was accepted for publication. This gives potential authors some idea of the lead time for publication in the journal.

h) The URL address to the online version [if available].

i) A correspondence address for one of the authors, preferably with an e-mail address.

j) A structured summary of 200-250 words. The structure of the summary should reflect the structure of the article, with the exception of the Discussion (Background, Material and methods, Results, Conclusions). An English summary should always be provided for articles published in another language, since only these are indexed by international data bases. If an English summary is given, a summary in the local language is optional.

k) 3-6 key words, which should not be words that also occur in the title of the article. The most desirable is to use key words from the MeSH catalogue. Both of these guidelines result from the fact that the purpose of key words is to assist researchers in searching data bases for articles that may be relevant to their field of interest, even if the title does not actually contain the target search string. Thus key words that repeat the title of the article are superfluous. English key words should always be provided for articles published in another language

6) Original research articles on medical topics should be presented according to the standard format used in medical publishing (with lower-order titles and subdivisions kept to a necessary minimum):

a) Structured summary (200-250 words, as described in [4.j.] above).

b) Introduction (or Background). The purpose of the study should be given in the Introduction, not as a separate section.

c) Material and methods. The description should be sufficient to allow another researcher to duplicate the experiment.

d) Results. Sufficient data should be given to allow an independent researcher to verify the results, including statistical analysis. All tables, graphs, photographs and figures should have legends in English (bi-lingual in journals published in other languages).

e) Discussion. This should also include some remarks on the limitations of the study and suggestions for future research.

f) Conclusions. Care should be taken not to present as “conclusions” statements that were not proven in the text.

g) Acknowledgements (if appropriate). Acknowledgement should be regarded as a form of expressing the authors' gratitude to those institutions or persons who enabled or facilitated the execution of the study, or otherwise made the study feasible, but did not make a personal contribution sufficient to justify co-authorship.

h) References. References should be presented in consecutive order (as they are cited in the text). If there are 2-6 co-authors, all should be listed; if more than 6, the first 3 should be listed followed by et al. Journal title abbreviations should be in Medline standard. Arabic numerals in bracket or in superscript should be used to mark citations in the text; in the References section, each citation item should be placed in a separate paragraph with the corresponding number.

i) Annex (if appropriate). The Annex may contain detailed descriptions of therapeutic and diagnostic techniques beyond the level of detail needed in the body of the article, samples of test forms and questionnaires used in the study, etc.

j) A list of non-standard abbreviations used in the text should be provided either at the beginning of the article or at the end, before Acknowledgements and References.

7) “Index Copernicus” journals with an interdisciplinary profile may use different structures and bibliographical conventions if the majority of their authors and readers are accustomed to them, but these should be applied consistently and in compliance with accepted standards in the respective fields.

8) Advertisements should be placed on editorial pages (at the beginning and/or at the end of the issue). The placement of advertisements within scientific content, i.e. directly before, inside, or directly after an article implies a commercial bias in the article, which is to be avoided.

9) All articles published within the journal should be reviewed prior to publication, and where possible, the review should be undertaken by more than one person (i.e. the Editor-in-Chief). Articles should only be published when they fulfill these criteria:

a) They are original works and have not been previously published

b) they contribute to the development of their subject, either by presenting new data, new interpretations or opinions, or new overviews of the topic

c) the content is not libelous, illegal, or an infringement of anyone's copyright or other rights.

d) they conform to the requirements of the journal (in particular the moral and ethical requirements) and they comply with the aims and scope of the journal and that their content is appropriate for the readership of the journal

10) In undertaking all activities related to the journal it is important that the members of the editorial team observe professional standards, including

a) respecting the confidence of authors (for example regarding patent and legal rights)

b) respecting the confidence of reviewers (for example when passing on criticisms of articles to the authors)

c) undertaking to process all submitted material in a timely manner, and not to unnecessarily delay any submissions

d) undertaking not to abuse the moral rights of the authors who submit to the journal, including misuse of the information they have submitted.

### III. International Availability

International availability is important for proper development of a scientific journal. Two factors are taken into consideration:

1. Language of publication. English is preferable, since this is the universal language of science. Journals published in other languages should have full size (200-250 words) structural summaries in English and bilingual article title as well as table/figure subtitles.

2. Internet availability. Internet becomes an important medium for scientific publication and exchange of professional information. It is due to its global availability and speed and low cost of publication, comparing to printed journals. Internet availability enhances a chance to broaden journal's circulation and speeds up its development. The access to editorial information, table of contents, summaries and full text articles and search tools are evaluated. The preferred language of a Website is English.

### IV. Frequency-Regularity-Market Stability

This group of parameters is to assess the editor's publishing/managing efficiency. We evaluate:
1. Regularity of issuance, which is an important factor for journal's stability and one of the key evaluation parameter at other international indexing databases such as Medline and Current Contents. Journals of an irregular issuance, late, or those, which issue joint issues, receive a lower score.
2. We add score to journals depending on their continuous presence on the market.

### V. Technical Quality

Technical quality discloses the ability for proper presentation of the scientific content. The quality of pre-print process, especially desk top publishing (DTP), ability to print in color, and the quality of paper (acid-free is preferred) are evaluated. The A4 format of a journal is preferred.

The detailed parametric analysis for Scientific Quality, Editorial Quality, International Availability, Frequency-Regularity-Stability, and Technical Quality is summarized in the charts below:

Detailed Parametric Analysis

| | | Item | Sub |
|---|---|---|---|
| | | score | Total |
| Scientific Quality | | | |
| International indexation | ISI | | |
| | Master Journal List = 50 | | |
| | SCI Expanded/other products = 50 | | |
| | Current Contents LS/CM = 50 | 150 | |
| | Index Medicus/Medline | 100 | |
| | Other | 50 | |
| Original papers published [in %] | Score equivalent to percentage | 100 | |
| International papers | Total number of papers of authors outside of the journal's | 100 | |
| | country of origin, published per year | | |
| Total number of papers published | | 40 | |
| per year | | | |
| International Editorial | Score equivalent to percentage but not more than 40 | 40 | |
| representation | | | |
| | Scientific Quality Sub-Total | | 580 |
| Editorial Quality | | | |
| Cover Page | All the following items appear clearly on the journal's cover | | |
| Title | | 0 | |
| Volume number | | 3 | |
| Issue/part number | | 3 | |
| Month | | 3 | |
| Year | | 3 | |
| ISSN | | 4 | |
| Frequency | | 4 | 20 |
| Editorial Details | | | |
| Full list of Editors | | 10 | |
| Country of Editors | | 5 | |
| Identification of editorial role | | 5 | |
| Scope of the journal | Clearly defined aims and audience | 5 | |
| Supporting body | Information about what learned society/association or other | 5 | |
| | body supports the journal | | |
| Funding body | Acknowledgement of funding sources for the journal | 5 | |
| Editorial contact information | Postal address [1], phone [1], fax [1], e-mail [1] and contact | 5 | |
| | person [1] | | |
| Publisher contact information | Postal address [1], phone [1], fax [1], e-mail [1] and contact | 5 | |
| | person [1] | | |
| Copyright statement | | 2 | |
| Volume of distribution | Number of copies per issue | 2 | 49 |
| Instructions for Authors | | | |
| Remit of journal | Clear statement | 2 | |
| Ethical issues/conflict of interest | Clear statement on the ethical issues in clinical and animal | 5 | |
| | research has to be provided; conflict of interest statement, | | |
| | patient confidentiality issues, permissions and copyright | | |
| | transfer policy should be indicated | | |
| Types of articles accepted | | 2 | |
| Editorial standards | Statement of journals confirmation to international editorial | 3 | |
| | standards | | |
| Review process | Statement on peer-review process | 3 | |
| Authors declaration | Authors required to state that their material is original and | 2 | |
| | not previously published/submitted elsewhere | | |
| Copyright statement | | 2 | |
| Instruction on manuscript | | 8 | |
| structure | | | |
| Instruction on graphics/photo | | 3 | |
| preparation | | | |
| Instruction on references | | 4 | |
| Address for submission | Postal | 3 | |
| | e-mail [e-submission opportunity] | 3 | 40 |
| Manuscript content presentation | | | |
| Title [English or bi-lingual] | | 5 | |
| Authors names [and initials] | | 5 | |
| Corresponding author identified | | 5 | |
| Authors contribution indicated | | 5 | |
| Correspondence info | Postal address [2]; phone [2]; e-mail [2] | 6 | |
| Affiliation | | 5 | |
| Date of submission/acceptance | | 5 | |
| Abstract[in English] | Less than 150 words [0]; non-structured [5]; structured [10] | 10 | |
| keywords | | 5 | |
| Consistent heading structure | | 10 | |
| Citation on 1^{st} page | | 5 | |
| Copyright on 1^{st} page | | 5 | |
| Reference list | Concise style of references [preferred consecutive order] | 10 | 81 |
| Subscription information | Price | 5 | |
| | How to order | 5 | 10 |
| | Editorial Quality Sub-Total | | 200 |
| Circulation/Availability | | | |
| Print Version | | | |
| Language of publication | Local only [5]; English summaries <150 words [20]; All in | 50 | |
| | English [50] | | |
| Clear indication of website | | 5 | |
| location in printed version | | | |
| Online Version | | | |
| Homepage | Homepage only [5]; can be located via Google [10] | 10 | |
| English or multi-lingual | | 20 | |
| Content shown | TOC only [5]; Abstracts [10]; full text in XMLor PDF [20] | 20 | |
| Search engine | By issues [5] + by keywords [10] + by authors [20] | 20 | |
| Free access | | 10 | |
| | Circulation/Availability Sub-Total | | 135 |
| Stability of the journal | | | |
| Issuance | Annually/bi-annually [5]; quarterly [15]; bi-monthly [20]; | 40 | |
| | monthly [40] | | |
| Age of journal | One point for each year up to 10 years (max 10 pts) | 10 | |
| | Stability of the Journal Sub-Total | | 50 |
| Technical Quality/Production Values | | | |
| Paper quality | Suitable for content | 5 | |
| Print quality | No fading print, | 5 | |
| Illustration quality | | 5 | |
| Photographs quality | Color add score | 5 | |
| Design quality | Text fills to the page well, not too small, not too large | 5 | |
| | Clearly laid out | 5 | |
| | Consistent design throughout | 5 | |
| | Technical Quality/Production Values Sub-Total | | 35 |
| Negative Score | | | |
| Advertisement placement | Within articles | −60 | |
| | Between articles [before or after article] | −40 | |
| Irregular issuance | Late [up to one month delay] | −30 | |
| | Joined issues | −50 | |
| | Very late [over one month delay] | −60 | |

| | | |
|---|---|---|
| Experts Peer-Review Opinion | | |
| Experts evaluate the journals scientific | | |
| content and give their opinion on the | | |
| | Scientific quality of published articles | [−20] . . . [+20] |
| | Up-to-date content | [−20] . . . [+20] |
| | Educational values | [−20] . . . [+20] |

The present invention is not to be limited in scope by the embodiment disclosed in the example which is intended as an illustration of one aspect of the invention and any methods which are functionally equivalent are within the scope of the invention. Indeed, various modifications of the invention in addition to those shown and described herein will become apparent to those skilled in the art from the foregoing description. Such modifications are intended to fall within the scope of the appended claims.

Those skilled in the art will recognize, or be able to ascertain using no more than routine experimentation, any equivalents to the specific embodiments of the invention described herein. Such equivalents are intended to be encompassed by the claims.

What is claimed is:

1. A system for evaluating scientific performance data, the system comprising:
a) an evaluating device connected to a data storage base configured to store a plurality of evaluation forms;
b) a member user connected to the evaluating device, the member user being configured to receive the evaluation forms and to transmit at least one completed evaluation form to the evaluating device, wherein the evaluating device is configured to generate a report evaluating the performance data based on analysis of responses made in the completed evaluation forms; and
c) a plurality of storage data bases connected to the evaluating device to receive and store the evaluation report generated.

2. The system according to claim 1, wherein the evaluation forms are based on identified parameters including a) personal identification and contact information, b) current position and employment history, c) education, specialties, titles, and scientific degrees, d) membership in scientific societies, e) membership in journals and editorial boards, f) reviewer of scientific journals, g) reviewer of grants, h) membership on graduate student committees, i) academic positions, j) grants, k) patents, l) scientific prizes and honors, m) other honors, n) scientific meetings, or publications.

3. The system according to claim 1, wherein the scientific performance data is obtained from scientific institutions, scientists, universities or industry.

4. The system according to claim 1, wherein the plurality of storage data bases include scientific data on journals, news articles, scientists, ongoing research projects, clinical trials, case reports, patents, grants, funding opportunities, business organizations, job postings, medical consultants, therapeutics directory, professional or career development.

5. The system according to claim 1, further comprising a data base to record the number of downloads registered for accessing articles by scientists who use the system and calculating a value score.

6. The system according to claim 1, further comprising a data base to calculate a scientist's research potential factor score as i) the sum of original publications of a scientist in any or selected journals+number and size of grants awarded to the scientist+the number of research projects being conducted by the scientist, as a function of the Index Copernicus Value.

7. The system according to claim 6, further comprising a data base to calculate a “scientist's impact factor” of a scientist as a number of citations of articles published by a scientist in the current year for articles published in previous two years, divided by the number of articles published by the scientist in those two years in all journals or in a selected category of journals.

8. The system according to claim 1, further comprising a data base to estimate an innovation potential factor of a scientist based on a cumulative score of the total number of patents issued (and/or pending) to the scientist+corresponding foreign patents,+number of patents that result in technology development and commercialization.

9. The system according to claim 1, further comprising a data base to estimate a “teaching potential factor” of a scientist based on scores for number of publications such as review articles and books+role as advisor or mentor to graduate and postgraduate candidates+participation as faculty for continuing education programs, divided by ICV.

10. A method of evaluating scientific performance data, said method comprising the steps of:
a) selecting and sending to a member user, an evaluation form for evaluating the scientific performance data, the evaluation forms being used to solicit feedback from a member user,
b) receiving the completed evaluation form from the member user,
c) evaluating the scientific performance data based on feedback received in the completed evaluation form to generate evaluation reports and tables, and
d) storing the evaluation reports and tables in a plurality of storage data bases.

11. The method according to claim 10, further comprising the step of assigning a numeric score on the responses received in the evaluation form.

12. The method according to claim 10 wherein a plurality of evaluation forms representing a plurality of parameters are used, further comprising the step of assigning scores to each evaluation form, and calculating the total score for all parameters.

13. The method according to claim 10 further comprising the step of recording the number of downloads registered for accessing articles by scientists who use the system and calculating a value score.

14. The method according to claim 10 further comprising the step of calculating a scientist's research potential factor score as i) the sum of original publications of a scientist in any or selected journals+number and size of grants awarded to the scientist+the number of research projects being conducted by the scientist, as a function of the Index Copernicus Value.

15. The method according to claim 14 further comprising the step of calculateing “scientist's impact factor” of a scientist as a number of citations of articles published by a scientist in the current year for articles published in previous two years, divided by the number of articles published by the scientist in those two years in all journals or in a selected category of journals.

16. The method according to claim 10 further comprising the step of estimating an innovation potential factor of a scientist based on a cumulative score of the total number of patents issued (and/or pending) to the scientist+corresponding foreign patents,+number of patents that result in technology development and commercialization.

17. The method according to claim 10 further comprising the step of estimating a “teaching potential factor” of a scientist based on scores for number of publications such as review articles and books+role as advisor or mentor to graduate and postgraduate candidates+participation as faculty for continuing education programs, divided by ICV.

18. A method for generating an evaluation form for evaluating scientific performance data of a member user, the method comprising the steps of:
a) identifying the parameter for the evaluation form;
b) generating content for the evaluation form based on the identified parameters;
c) generating the evaluation form including the content, the content soliciting quantifiable and open-ended responses from the member user; and
d) assigning a numeric score for the evaluating forms based on the responses received.

19. The method according to claim 18 wherein the content of the evaluation form is
associated with a plurality of parameters and the step of assigning the numeric score further comprises the step of:
determining a score for each parameter based on a plurality of responses; and
calculating the numeric evaluation score based on the parameter scores.

20. The method according to claim 18 further comprising the step of recording the number of downloads registered for accessing articles by scientists who use the system and calculating a value score.

21. The method according to claim 18 further comprising the step of calculate a scientist's research potential factor score as i) the sum of original publications of a scientist in any or selected journals+number and size of grants awarded to the scientist+the number of research projects being conducted by the scientist, as a function of the Index Copernicus Value.

22. The method according to claim 21 further comprising the step of calculating a “scientist's impact factor” of a scientist as a number of citations of articles published by a scientist in the current year for articles published in previous two years, divided by the number of articles published by the scientist in those two years in all journals or in a selected category of journals.

23. The method according to claim 18 further comprising the step of estimating an innovation potential factor of a scientist based on a cumulative score of the total number of patents issued (and/or pending) to the scientist+corresponding foreign patents,+number of patents that result in technology development and commercialization.

24. The method according to claim 18 further comprising the step of estimating a “teaching potential factor” of a scientist based on scores for number of publications such as review articles and books+role as advisor or mentor to graduate and postgraduate candidates+participation as faculty for continuing education programs, divided by ICV.
